(19) United States
(12) Patent Application Publication
(10) Pub. No.: US 2016/0273953 A1
(43) Pub. Date: Sep. 22, 2016

(54) METHOD FOR MONITORING THE FILLING LEVEL IN A COLLECTION CHAMBER, AND MONITORING ARRANGEMENT

(71) Applicant: BEKO TECHNOLOGIES GMBH, Neuss (DE)

(72) Inventor: Herbert SCHLENSKER, Leverkusen (DE)

(21) Appl. No.: 14/784,180

(22) PCT Filed: Dec. 16, 2014
(86) PCT No.: PCT/EP2014/077934

§ 371 Date: Oct. 13, 2015

(30) Foreign Application Priority Data
Dec. 16, 2013 (DE) 10 2013 114 123.4

(51) Int. Cl. G01F 23/284

(52) U.S. Cl. CPC G01F 23/284

(57) ABSTRACT

A method for electronically monitoring a filling level of a liquid in a collection chamber relates to a condensate in a compressed gas system and includes a monitoring means corresponding with an analysis unit for detecting the fill level. The monitoring component is arranged in the region of the collection chamber and corresponds to an evaluation unit for detecting the filling level. An RFID transponder is used as the monitoring means. Alternatively, the monitoring component may include an RFID transponder. In this case, the evaluation unit generates an at least temporary electromagnetic field which is influenced by feedback from the monitoring component to an extent which can be recorded by the evaluation unit. The method further relates to a monitoring arrangement for electronically monitoring the filling level of a liquid in a collection chamber.

### FIELD

The disclosure relates to a method for electronically monitoring the fill level of a liquid in a collecting space, particularly a condensate in a compressed-gas system.

### BACKGROUND

The loss of water from atmospheric air is well known. This is caused by certain temperature and pressure conditions, under which the water dissolved in the air as water vapour condenses. By contrast, condensate regularly accumulates during the compression of atmospheric air, because compressed air can only accommodate a little water. Because an ever increasing quantity of condensate is therefore deposited and collected over time in compressed-gas systems in particular, such as for example in compressed-air systems, it is necessary to dissipate it.

To this end, systems of this type for the most part have a steam trap. This comprises a valve arrangement to be actuated manually or regulated automatically, via which the condensate can be drained from the system. Conventional controls therefore have a mechanically float-controlled valve or even a manual valve. Further configurations provide a time-controlled solenoid valve for example. The reliable function of arrangements of this type is not permanently ensured under certain circumstances. In addition to the sometimes high installation costs, possible energy losses are also added, which can occur during the draining of the condensate from the compressed-gas system.

Furthermore, electronic steam traps have also become established, which enable an automatic level-controlled operation. A configuration of this type is to be mentioned in connection with low-energy-loss drainage of condensate from compressed-gas systems in particular. Systems of this type have at least one sensor, which is arranged in direct contact with the liquid accumulating within the system.

A device for draining condensate out of a compressed-gas system is already known from DE 197 14 037 A1. To this end, the device comprises a collecting space with an outlet. The collecting space is constructed for accommodating condensate accumulating during the operation of the compressed-gas system, whilst the outlet is used for the drainage thereof out of the collecting space. A fill-level meter is arranged inside the collecting space, which has an electronic, preferably capacitive sensor. In this case, the sensor is arranged such that it is possible to thereby detect an upper and a lower level of the condensate inside the collecting space. In order to then ensure a regulated drainage of the condensate out of the collecting space as a function of the actual accumulation thereof, electronics are furthermore provided for controlling an external valve arrangement. This comprises a time circuit, which is provided for opening the valve arrangement after the expiry of a pre-set time interval. In this case, the electronics are constructed in such a manner that the time circuit is started with a closed valve arrangement. As soon as draining condensate falls below the lower level with the valve arrangement open, the signal generated by the sensor is used in order to close the valve arrangement and the time circuit is restarted, if an upper level is reached again in the collecting space. Due to the suggested configuration, the actual steam trap manages without its own collecting space, as it uses the already existing collecting space in the compressed-gas system. As a result, the simplified and therefore cost-effective construction thereof is enabled.

DE 43 12 432 A1 describes a device which is used for measuring liquid levels. This comprises a container which has two uninsulated and mutually spaced electrodes for construction as a measuring cell. A low-concentration electrolyte is necessary to make it possible to use measurement technology to determine the liquid levels. In other words, the suggested device is suitable for liquids with which it is possible to form a galvanic cell, comparable to a rechargeable battery, in a combination made up of a container and electrodes. In this manner, the device can be used in a relaxation oscillator such that the frequencies of the relaxation oscillator dependent on the electrodes covered with the electrolyte can be called upon for the measurement.

Conventional automated devices are all built such that they include either mechanical or electronic triggering for draining the condensate. In this case, the respective sensor or the float must itself be in contact with the condensate. To this end, it is necessary that it be arranged inside the compressed-gas system at least to some extent, for example inside a suitable collecting space for the condensate. In order to then be able to produce the required connection to further components, the arrangement thereof sometimes requires access openings, which are complicated to seal. These are necessary, in order to guide a mechanism or else a supply or signal line through them for example. As one is concerned here with systems that are regularly under high pressure, regions of this type therefore demand conceptually complex designs and increased awareness with reference to the maintenance thereof.

With regards to electronic systems for condensate drainage, which are of as compact a construction as possible and simple and inexpensive in terms of manufacturing and arrangement, these therefore also leave further room for improvements with reference to the design and the operation thereof.

### SUMMARY

Against this background, the present disclosure is based on improving a method for electronic fill-level monitoring of a liquid in a collecting space and also a monitoring arrangement for electronic fill-level monitoring of a liquid in a collecting space such that the same allows an option for regulated drainage of condensate out of a compressed-gas system, which manages with a minimum of components and is durable as well as simple to retrofit.

The method according to the disclosure for electronically monitoring the fill level of a liquid in a collecting space is explained in the following. The liquid may be any non-gaseous fluids, particularly condensate. Preferably, the method is used in a compressed-gas system, in order to monitor the fill level of the condensate accumulating therein.

A monitoring means and an analysis unit are used in order to carry out the fill-level monitoring of the liquid. In order to detect the respective fill level of the liquid, the monitoring means is preferably arranged in the region of the collecting space. Of course, the monitoring means can also be used at other locations, where liquid collects or can collect. In this respect, the collecting space used in the context of the disclosure is to be understood to mean any configuration which allows the accommodation of accumulating or possibly accumulating liquid. In this case, the issue is rather that a level of the liquid inside the collecting space, which describes the fill level, can decrease and/or increase.

Thus, the collecting space can for example be a part of a compressed-gas system constructed as a vessel, particularly a separating housing or filter housing. Alternatively, the collecting space can also be constructed as an additional element, which is for example arranged on or in a compressed-gas system. Of course, the collecting space can for example be connected to a compressed-gas system in such a manner that the same is coupled to the compressed-gas system in a fluid-conducting manner via a suitable supply line.

The compressed-gas system mentioned in the context of the disclosure can for example be a compressed-air system. Furthermore, monitoring means and analysis unit are configured such that they can correspond with one another in order to detect the respective fill level of the liquid. The monitoring means can advantageously be arranged directly in the filter housing of a compressed-gas system.

According to the disclosure, it is provided that an RFID transponder is used as monitoring means. In the context of the disclosure, it is seen as an alternative option that the monitoring means comprises at least one RFID transponder. In this case, the analysis unit is constructed such that an at least temporary electromagnetic field is generated by it. The electromagnetic field is preferably a high-frequency electromagnetic alternating field. Depending on the configuration, it can alternatively also be a low-frequency or medium-frequency induction transmission.

In this case, temporary is for example understood as meaning a field generation taking place after a predetermined interval. Alternatively or in combination herewith, temporary is also understood as meaning an unrhythmic generation of the electromagnetic field, which only takes place when necessary. Here, this can also be field generation taking place according to the randomness principle for example. Of course, depending on the configuration, it may also be advantageous if the generation of the electromagnetic field takes place over a relatively long period of time or else permanently.

Permanently is understood as meaning a time period in which for example a compressed-gas system monitored with respect to its liquid fill level is operating in the context of the method according to the disclosure.

According to the inventive idea, the electromagnetic field generated by the analysis unit can be influenced by the monitoring means. The influencing of the electromagnetic field in this case takes place in the form of feedback of the monitoring means. In this case, it is to be emphasised that the influencing of the electromagnetic field and therefore the feedback of the monitoring means takes place to an extent which can be registered by the analysis unit.

The particular advantage of the method according to the disclosure lies in the use of an RFID transponder either as monitoring means or in combination with the same. As the RFID transponder can be operated without a physical supply line or connection, the parts necessary for carrying out the method are essentially limited to the pure arrangement of the monitoring means and the analysis unit. This results in a very easily understandable construction that can be realised with only little outlay, as the correspondence between monitoring means and analysis unit takes place wirelessly.

The RFID transponder used as monitoring means in the context of the disclosure has at least one antenna and an analogue circuit. In this case, the analogue circuit is constructed in order to send at least one signal in the form of a feedback. Furthermore, the antenna is constructed to be exposed to the electromagnetic field generated by the analysis unit. The energy absorbed in the process via the antenna from the electromagnetic field is used in the form of high-frequency energy to supply the RFID transponder with energy and thus to operate the same.

As an alternative to the previously described passive RFID transponder, an active RFID transponder can also be used. This differs from the passive RFID transponder in that this has its own energy source. The advantage thereof lies in the mostly higher range and also an expanded or expandable range of functions. Thus, RFID transponders of this type can take on additional tasks, in that they contain a further sensor for example. By contrast, passive RFID transponders offer low production costs and also continuous operation independent of an own energy source. To this end, RFID transponders may have a capacitor, which is charged by the energy absorbed from the electromagnetic field. The feedback thereof when generating the electromagnetic field for the most part takes place in a time-delayed manner until the capacitor has a satisfactory charge state for the pending feedback to the analysis unit.

Furthermore, alternatively, the RFID transponder used can be a semi-active RFID transponder. The advantage thereof lies in great economy, as it does not have its own transmitter. In order to then deliver feedback to the analysis unit, the semi-active RFID transponder only modulates its backscatter coefficients to the electromagnetic field.

Consequently, the use of the RFID transponder as monitoring means is initially orientated such that the presence thereof in the vicinity of the analysis unit is detected by the same.

In an advantageous development of the basic inventive idea, it is provided that the monitoring means and the analysis unit are arranged in such a manner with respect to one another that the respective fill level, that is to say the level of the liquid between the monitoring means and the analysis unit can increase and/or fall. In other words, in this manner, the fill level of the liquid between the monitoring means and the analysis unit can fluctuate up and down. In this connection, use is made of the fact that the electromagnetic field is at least partially absorbed to the same degree by the fill level which is increasing between the monitoring means and the analysis unit.

To this end, the RFID transponder used can preferably operate with very high frequencies (UHF), for example with 433 MHz or else 850 to 950 MHz. In the case of UHF transponders of this type in particular, the UHF energy in particular is very strongly absorbed by water, so that an extremely accurate and reliable detection of the presence of water between the monitoring means and the analysis unit is enabled.

Overall, an extremely simple structure and therefore an extremely simple operation of the method according to the disclosure may result from this. In this case, the inventive idea makes use of the discovery that liquids—particularly water—exert a sometimes strongly absorbing effect on an electromagnetic field. Consequently, the RFID transponder is here primarily used purely for feedback as a reaction to the electromagnetic field generated by the analysis unit. In this case, the said feedback is changed in the form of influencing of the electromagnetic field to the same extent as the electromagnetic field is absorbed by the rising level of the liquid and therefore with increasing fill level. Because of this change of the inherently constant electromagnetic field, the analysis unit can draw conclusions about the current fill level of the liquid inside the collecting space.

In other words, a disruption of the communication between the monitoring means and the analysis unit, which disruption is generated by the liquid, is therefore used as a useful signal. In principle, the RFID transponder is merely used as an echo transmitter; the information content or the context of the transmitted signal is not important in this case. The contribution of the damping of the radio signal by the liquid is used as an indicator, as it were. This field noise or the change in the field strengths, which is sensed in conventional applications as a disturbance variable and is for the most part compensated with more or less comprehensive measures there, is the desired and evaluated effect here according to the disclosure.

According to a further advantageous configuration, the disclosure provides that the monitoring means can be coupled to a sensor. In this case, the sensor is constructed to detect a fill level or the level of the liquid inside the collecting space. The sensor can be an additional component, which is coupled in a suitable manner to the monitoring means. Of course, the sensor can however also be part of the monitoring means.

In this context, it is seen as an advantageous development, if the RFID transponder itself is both monitoring means and sensor. To this end, the RFID transponder can have at least one digital circuit, which is used for detecting at least one level with respect to the fill level of the liquid in the collecting space. Furthermore, this can also be configured in such a manner that at least two or more levels can be detected.

In any case, the digital circuit is then used to transmit the respective result of the fill-level measurement to the analysis unit wirelessly in the form of a value. To this end, the electromagnetic field generated by the analysis unit can be changed in such a manner as a function of the fill level detected by the sensor that the detected fill level is transmitted to the analysis unit.

In order to extend the inventive idea further, the monitoring means and the analysis unit can function as a part of an electronic monitoring arrangement. The said monitoring arrangement is then advantageously coupled to a valve arrangement, which is in turn connected in a fluid-conducting manner to the collecting space. The valve arrangement has a suitable drive or is at least connected to such, in order to open the valve arrangement to drain liquid and subsequently to close the same. The at least one valve of the valve arrangement can for example be a rotary valve or else an electromagnetic valve.

It is possible by means of the previously described arrangement that the valve arrangement can be opened upon reaching or exceeding an upper fill level of the liquid inside the collecting space, in order to drain at least a part of the liquid from the collecting space. Upon reaching or falling below a lower fill level of the liquid inside the collecting space, the valve arrangement can be closed again.

In this manner, an electronic level-controlled regulating arrangement can be created, which is used for a regulated drainage of collected liquid from the collecting space.

With reference to the previously illustrated embodiment as electronic monitoring arrangement, it is conceived in the context of the disclosure that the opening or closing of the valve arrangement takes place on the basis of a detected fill level. As an alternative or in combination, the opening and/or the closing of the valve arrangement can also take place after the expiry of a previously defined time interval. In other words, the valve arrangement can for example be opened by means of the detected reaching or exceeding of an upper fill level, in order to drain a part of the liquid from the collecting space. The subsequent closing of the valve arrangement can then take place after the expiry of a predefined time interval. Conversely, the closing of the valve arrangement can take place by means of the detected reaching of or falling below a lower fill level, while the required opening of the valve arrangement takes place after the expiry of a predefined interval after the closing of the same. Of course, the respective interval can also be linked to further measured parameters and therefore be changed dynamically. For example, it would be conceivable here to measure the moisture within a compressed-gas system, which can give information about the possible accumulation of condensate.

The opening and closing of the valve arrangement can fundamentally also be controlled by the detected reaching and falling below or exceeding of a fill level, however.

Thus, it is conceivable according to a further advantageous development of the disclosure that the method is carried out with at least two monitoring means. The said monitoring means are spaced from one another in this case, in order to detect at least two fill levels that differ from one another. To this end, it is provided that when draining or collecting the liquid from or in the collecting space, the time between the passage of the two monitoring means by the decreasing or increasing fill level can be measured. In this manner, a statement can be made about the respective flow-off behaviour of the liquid, in that it is measured in relation to the speed of the drainage of the liquid.

The previously described method according to the disclosure now results in an extremely advantageous option for electronic fill-level monitoring of a liquid in a collecting space, which manages with a minimum of components. A durable option for the regulated drainage of condensate from a compressed-gas system is enabled in particular by means of the use of an RFID transponder as monitoring means, thanks to the wireless correspondence between this and the analysis unit. Moreover, the embodiment according to the disclosure shows an advantageous option for the simple retrofitting of pre-existing compressed-gas systems, which can take place in a virtually minimally invasive manner via a relatively small opening in the collecting chamber.

By directly arranging the monitoring means or the RFID transponder in the collecting chamber or filter housing, the so-called airlock problem can also advantageously be solved. This is based on the fact that a line is often guided from the collecting chamber or filter housing to a steam trap, in which a liquid level is detected and by which a valve of the collecting chamber is opened in the event of too high a liquid level. If there is an air bubble in this supply line to the steam trap, the liquid level does not continue to rise in the steam trap, so that it also cannot release the corresponding valve. The liquid can nonetheless increase inside the collecting chamber, without this being registered.

According to the disclosure, it is therefore provided that the monitoring means or the RFID transponder is arranged directly in the collecting chamber or filter housing, so that the supply line is dispensed with completely and therefore the airlock problem can be circumvented.

Alternatively to the above-described advantageous design variant, the system according to the disclosure can however also be arranged in an external steam trap, which, is connected to the collecting chamber via a supply line. Although this may be disadvantageous with regards to the airlock problems, other advantages may prevail, so that this arrangement may be used in spite of that. In this case, both the monitoring means and the analysis unit are arranged externally to the collecting chamber in the steam trap, which is connected via a line to the collecting chamber. If the liquid level increases too quickly, a likewise externally arranged valve is opened, which drains liquid out of the collecting chamber and also out of the steam trap.

Furthermore, the disclosure also provides a monitoring arrangement for electronically monitoring the fill level of a liquid in a collecting space. The said monitoring arrangement can in particular be used for carrying out the previously indicated method according to the disclosure. The monitoring arrangement according to the disclosure is explained in more detail hereinafter:

The monitoring arrangement according to the disclosure initially comprises at least one monitoring means and also an analysis unit. In this case, the monitoring means is therefore provided to preferably be arranged in the region of the collecting space, particularly in a filter housing. According to the disclosure, the monitoring means itself is an RFID transponder or at least comprises one such. The analysis unit is furthermore constructed to receive a wirelessly transmitted signal of the monitoring means.

The monitoring means or the RFID transponder is advantageously arranged at a free end of a rod or is itself realised in a rod-shaped manner. If the RFID transponder is arranged on a rod, the road is used as a retaining device for the RFID transponder, as it were. The rod-shaped design has the substantial advantage that the diameter of the retaining device with the RFID transponder is exceptionally small and therefore can be inserted into the smallest openings of the collecting chamber, which facilitates an arrangement of the monitoring means (RFID transponder) inside the collecting chamber. The collecting chamber has one such opening for example anyway for draining the liquid, so that it is not necessary to introduce an additional opening. According to the disclosure, the introduction of a second opening can however be conceivable in spite of this, should this be advantageous for reasons of geometry. A suitable RFID transponder for example has a diameter of approximately 2 to 5 mm, preferably approximately 2.5 mm, and is 10 mm to approximately 30 mm long, preferably approximately 12 mm. Other dimensions are also conceivable of course.

The introduction of the rod with the monitoring means is therefore also possible for terminal cross sections of ⅛ inch to ¾ inch, in particular, the conventional openings with a diameter of ¼ inch can be used.

The spacing of the monitoring means from the analysis unit, which can adjoin the rod on the opposite side, is preferably 5 cm, however spacings of up to 20 cm are also conceivable. This ultimately depends on the transmission/receiving performance of the system and in particular may also vary in future.

In the rod-shaped design variant according to the disclosure, the analysis unit is arranged outside of the collecting chamber, which is much easier with regards to energy supply in particular if the monitoring means is passively designed and does not require an energy supply. However, a design variant can alternatively also be chosen, in which a rod-shaped arrangement is used in combination with an active monitoring means. In this case, the energy supply can for example take place by means of the rod, for example through an electrical line.

During operation, liquid is located inside the collecting chamber, between the monitoring means arranged at the end of the rod and the analysis unit arranged outside of the collecting chamber. This damps the signal strength between the monitoring means and the analysis unit, from which it is possible to conclude the liquid level or the quantity of liquid.

It is important that the liquid located in the collecting chamber can also be drained directly through the opening, through which the rod-shaped retaining device with the monitoring means is inserted. Thus, an additional collecting chamber is not required for an indirect measurement of the liquid level. The rod-shaped retaining device with the monitoring means is therefore part of a monitoring arrangement, by means of which liquid is drained. A valve is located in the same line for this purpose, which valve is opened and closed by the analysis unit, which in turn receives its signal from the monitoring means or from the RFID transponder. The liquid located in the collecting chamber therefore flows out of the collecting chamber along the rod-shaped retaining device through the opening and passes a valve located in this line. The valve can in this case be provided in the direct vicinity of the collecting chamber, but a further removed arrangement is also conceivable, however.

The advantages and options resulting in particular due to the use of the RFID transponder have already been explained in more detail in connection with the previously shown method according to the disclosure. To avoid repetitions, reference is at this point made to the previous statements, which are to be seen as more in-depth explanations of the monitoring arrangement according to the disclosure. This also applies incidentally for the advantageous embodiments of the monitoring arrangement according to the disclosure, which are explained hereinafter.

According to an advantageous development, it is provided that at least a part of the liquid collecting in the collecting space is arranged between the monitoring means and the analysis unit in such a manner that increasing or falling fill level can be detected by means of the disruption of the communication. In other words, here the disclosure proceeds from a spatial positioning of monitoring means and analysis unit.

The embodiment according to the disclosure can be compared, in the form of a pictorial comparison, with the typical design of a photoelectric barrier, which is not inherently suited to detecting transparent liquid, particularly water, however. Only the fundamental design of the arrangement being discussed here should therefore be clarified on the basis of the comparison with a photoelectric barrier. Thus, the analysis unit can be seen as a light source and simultaneously as a receiver for light in this comparison. By contrast, the monitoring means is used as a reflective element, which mirrors the light emitted by the analysis unit onto the receiver of the analysis unit. The increasing liquid in the collecting space can then be seen as at least partial interruption for the light.

Furthermore, the disclosure provides that the monitoring means either has direct contact to the liquid or can be arranged outside of the liquid. Thus, it is conceivable for example that the monitoring means is arranged inside the collecting space, while it corresponds wirelessly with the analysis unit arranged outside of the collecting space. As an alternative, monitoring means and analysis unit can also be arranged oppositely and enclose at least part of the collecting space between them. In this connection, it is considered advantageous if at least the part of the collecting space lying between the monitoring means and the analysis unit is formed from a non-metallic material. The background is that when using a UHF transponder in particular, the electromagnetic waves can be reflected strongly by the metal. As a result, the propagation of the antenna field can be negatively influenced, so that measurement errors can occur. Ultimately, it is left to the person skilled in the art to choose suitable materials in combination with the respective RFID transponder, which may differ from use case to use case, so it is not possible to make a universally applicable statement.

Nonetheless, the use of metallic materials in connection with compressed-gas systems is to be seen as preferred. This is because of the sometimes higher strength and the better resistance to higher and in particular high pressures, which is connected therewith. In this connection, it is seen as advantageous according to the present disclosure if a “teach in” takes place during initial commissioning of the monitoring arrangement.

In this context, teach in means the use of the programming-related intelligence of the RFID transponder, using which, the signal excursion or the signal interference resulting from the use of a metallic material can be eliminated. In this manner, the mostly shielding effect of such a metallic collecting space against further interference signals from outside can advantageously be used. Fundamentally, the option of the teach in can also be used in order for example to undertake a compensation of temperature and/or any contamination.

In this context, a further advantage is therefore seen overall in the embodiment according to the disclosure of the monitoring arrangement in terms of insensitivity with respect to any contamination.

Further embodiments of the method for electronically monitoring the fill level of a liquid in a collecting space or the monitoring arrangement for electronically monitoring the fill level of a liquid in a collecting space may result due to a technically sensible combination of individual or a plurality of features and measures indicated in the previous description and are also expressly claimed in the scope of the disclosure. Further characterisations and specifications of the disclosure, which are likewise considered and claimed as part of the disclosure, can in particular result in connection with the following description of the figures.

### BRIEF DESCRIPTION OF THE DRAWINGS

The disclosure is explained in more detail in the following on the basis of exemplary embodiments illustrated in the drawings. In the figures:

FIG. 1 shows a schematic illustration of a monitoring arrangement according to the disclosure in its basic design,

FIG. 2 shows the monitoring arrangement according to the disclosure from FIG. 1 in an alternative arrangement in the same representation format and

FIG. 3 shows the monitoring arrangement according to the disclosure from FIG. 2 in an alternative embodiment in the same representation format,

FIG. 4 shows a particularly advantageous design variant of the disclosure,

FIG. 5 shows a further advantageous design variant of the disclosure.

### DETAILED DESCRIPTION OF THE DRAWINGS

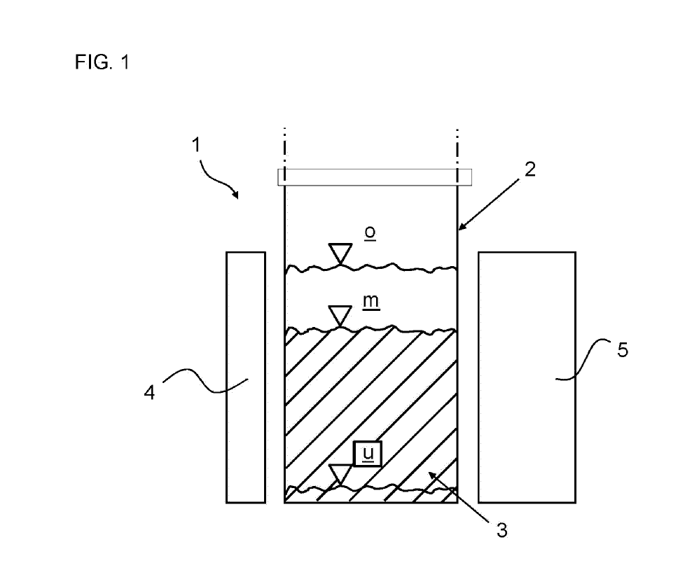

The basic structure of a monitoring arrangement 1 according to the disclosure emerges from FIG. 1. As can be seen, this first comprises a collecting space 2, which is used for accommodating accumulating liquid 3, for example condensate. The collecting space 2 can for example be part of a compressed-gas system, which is not shown in more detail. As an alternative, the collecting space 2 can also be an additional component, which is connected to a compressed-gas system in a fluid-conducting manner which is not illustrated in any more detail.

Furthermore, the monitoring arrangement 1 comprises a monitoring means 4 and an analysis unit 5. The detection means 4 is an RFID transponder. The monitoring means 4 is arranged in the region of the collecting space 2; but outside of the collecting space 2 and therefore outside of the liquid 3. In this manner, the monitoring means 4 does not come into contact directly with the liquid 3. The analysis unit 5 is constructed to receive a wirelessly transmitted signal of the monitoring means 4.

In the present case, at least a part of the liquid 3 collecting in the collecting space 2 is arranged between the monitoring means 4 and the analysis unit 5 in such a manner that the increasing or decreasing fill level of the liquid 3 between the monitoring means 4 and the analysis unit 5 can be detected. The level of the liquid is shown in the present case using an average fill level m, wherein this can fluctuate between an upper fill level o and a lower fill level u.

In this arrangement, the analysis unit 5 is able to generate an at least temporary electromagnetic field, which is not shown in any more detail and in influenced by a feedback of the monitoring means 4 to a degree that can be registered by the analysis unit 5. The respective fill level m, o, u of the liquid 3 in the collecting space 2 can thus be detected in particular by means of the absorbing effect of the liquid 3 on the electromagnetic field.

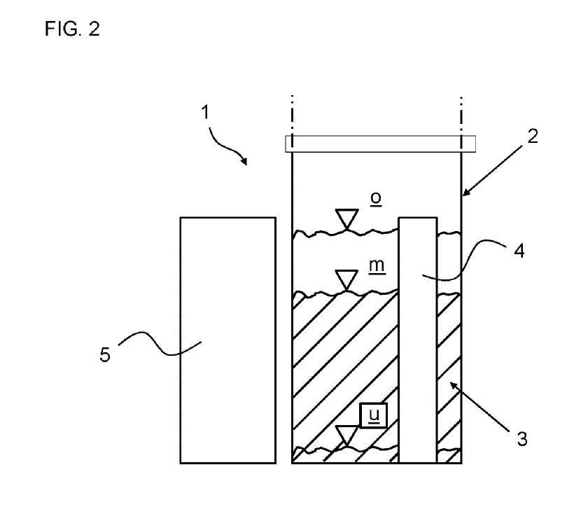

FIG. 2 shows an alternative arrangement of the monitoring means 4. This is then no longer arranged outside of the collecting space 2, but rather inside the collecting space 2, so that the monitoring means 4 now has direct contact with the liquid 3.

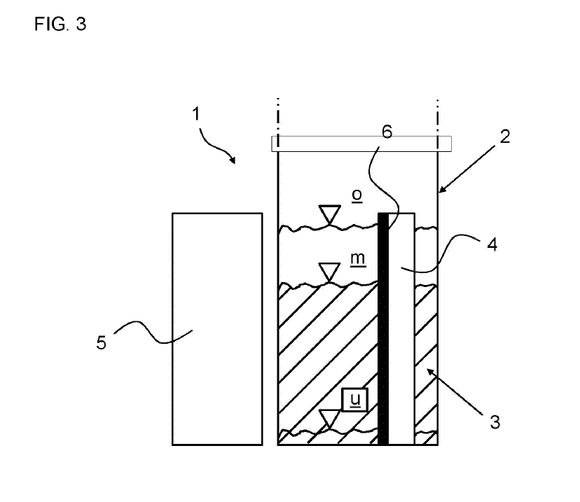

FIG. 3 clarifies an alternative embodiment of the monitoring arrangement 1 according to the disclosure. Here, the monitoring means 4 is furthermore arranged inside the collecting space 2, wherein it is connected to a sensor 6. In this case, the sensor 6 is likewise arranged inside the collecting space 2. The sensor 6 is constructed to actually detect a fill level m, o, u of the liquid 3 inside the collecting space 2.

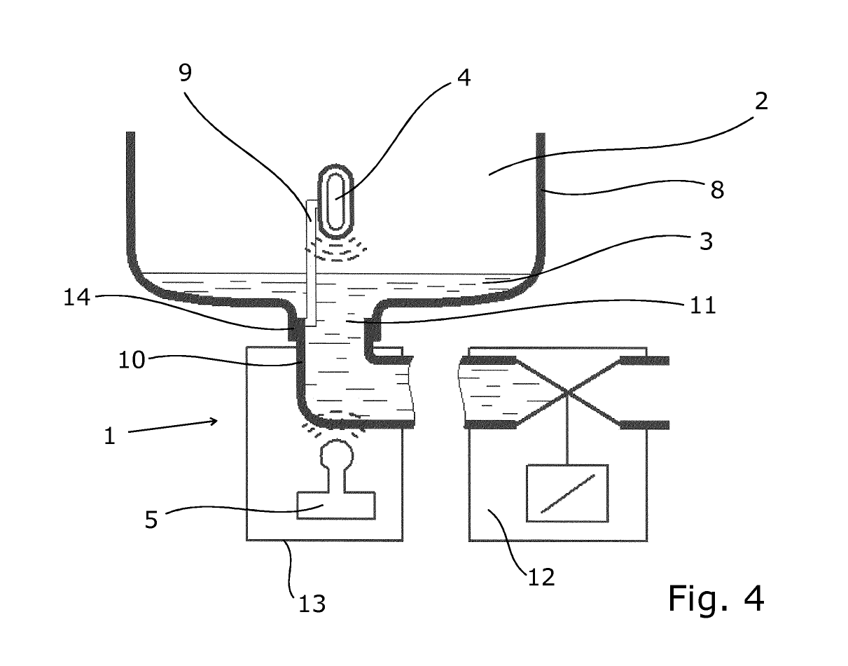

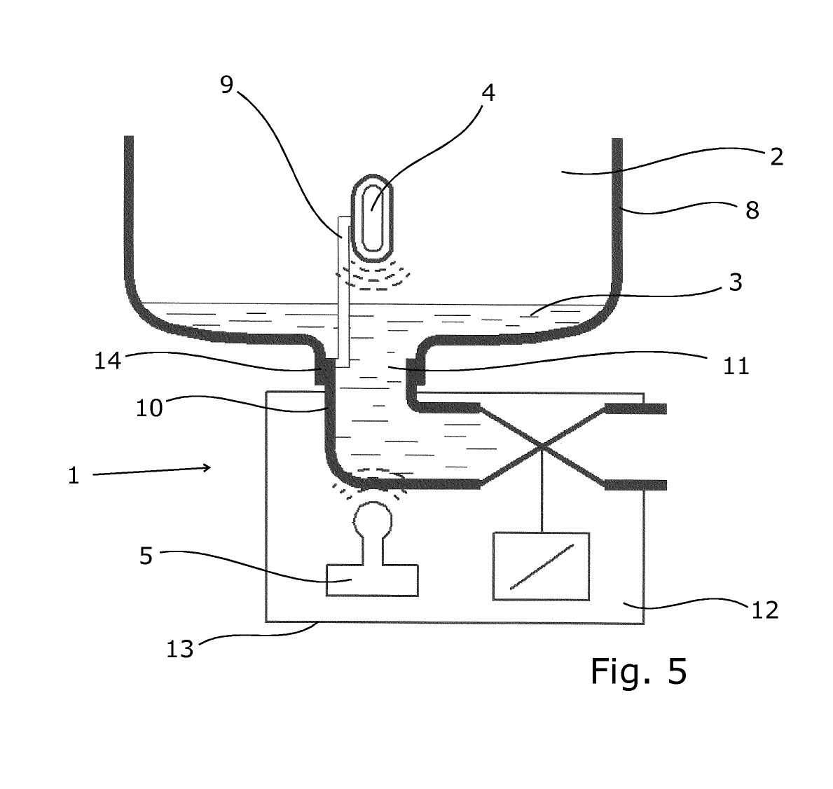

FIGS. 4 and 5 clarify a particularly advantageous design variant of the disclosure. A collecting chamber 8 can be seen, in which the collecting space 2 is located. Liquid 3 has collected inside the collecting space. The monitoring means 4 (preferably an RFID transponder) is arranged at the end of a rod 9. The rod 9 is therefore used as a retaining device for the monitoring means 4.

The rod 9 is arranged in or on a connection line 10; alternatively, it may also be an integral component of the same. The connection line 10 is in turn connected to an opening 11 of the collecting chamber 8 and is used for draining the liquid 3. The analysis unit 5 is likewise connected to the connection line 10. The radio connection between the monitoring means and the analysis unit is illustrated by dashed lines.

Furthermore, a controllable valve 12 is located in the course of the connection line 10. If the valve 12 is opened, the liquid 3 can flow out of the collecting space 2 through the connection line 10. The valve 12 is controlled by the analysis unit 5; this analyses the signals received from the monitoring means 4 and opens or closes the valve 12.

According to the disclosure, the monitoring arrangement 1 can be realised as a coherent component, which has the analysis unit 5 inside a housing 13 and contains or constructs a section of the connection line 10. It is important that the monitoring arrangement 1 contains the rod 9 with the monitoring means 4 arranged thereon. The monitoring arrangement 1 is configured in such a manner in this case that it can be inserted into the opening 11 of the collecting chamber 8, wherein the rod 9 with the monitoring arrangement 1 is inserted through the opening 11. For this purpose, a threaded connection can be provided between the opening 11 and the monitoring arrangement.

A connecting piece 14 is shown arranged on the collecting chamber 8, preferably with an internal thread, onto which the monitoring arrangement 1 can be screwed. Alternatively, a plug connection with a seal and a union nut, via which the connection line 10 is fastened on the connecting piece 14, is also conceivable. In both cases, an installation of the monitoring arrangement 1 on site is possible quickly and simply.

As already stated, the associated valve 12 can be arranged externally in the course of the connecting line (FIG. 4). Alternatively, as shown in FIG. 5, the valve 12 can be arranged as an integral component of the monitoring arrangement 1, likewise in the housing 13.

In all cases, the signal strength of the monitoring means 4 is absorbed by the liquid at least to some extent, wherein the analysis unit 5 detects the signal strength or the interference of the signal strength of the signal of the monitoring means 4.

1. A method for electronically monitoring a fill level of a liquid in a collecting space, wherein a monitoring means corresponds with an analysis unit for detecting the fill level, wherein an RFID transponder is used as the monitoring means or the monitoring means comprises an RFID transponder, wherein the analysis unit generates an at least temporary electromagnetic field, which is influenced by a feedback of the monitoring means to a degree that can be registered by the analysis unit.

2. The method according to claim 1, wherein an arrangement of the monitoring means and the analysis unit in such a manner relatively to one another that the electromagnetic field is absorbed the fill level which is increasing between the monitoring means and the analysis unit, and the analysis unit detects a signal strength of a signal of the monitoring means.

3. The method according to claim 1, wherein the monitoring means is coupled to a sensor, which is constructed to detect the fill level of the liquid, wherein the electromagnetic field is changed as a function of the fill level detected by the sensor that the detected fill level is transmitted to the analysis unit.

4. The method according to claim 1, wherein the monitoring means and the analysis unit are part of an electronic monitoring arrangement, which is coupled to a valve arrangement connected in a fluid-conducting manner to the collecting space, wherein the valve arrangement is opened upon reaching or exceeding an upper fill level to drain at least a part of the liquid from the collecting space.

5. The method according to claim 1, wherein the monitoring means is arranged in the region of the collecting space.

6. The method according to claim 1, wherein the monitoring means and the analysis unit are part of an electronic monitoring arrangement, which is coupled to a valve arrangement connected in a fluid-conducting manner to the collecting space, wherein the valve arrangement is opened for the regulated drainage of the liquid from the collecting space, and upon reaching or falling below a lower fill level, the valve arrangement is closed.

7. The method according to claim 1, wherein at least two mutually spaced monitoring means, wherein when draining or collecting the liquid out of or in the collecting space, the time between the passage of the monitoring means by the fill level is measured to measure the flow-off behaviour of the liquid.

8. A monitoring arrangement for electronically monitoring the fill level of a liquid in a collecting space for carrying out the method according to claim 1, the monitoring arrangement comprises a monitoring means and also an analysis unit, wherein the analysis unit is configured to receive a wirelessly transmitted signal of the monitoring means.

9. The monitoring arrangement according to claim 8, wherein the monitoring means is an RFID transponder or includes an RFID transponder.

10. The monitoring arrangement according to claim 8, wherein at least a part of the liquid collecting in the collecting space is arranged between the monitoring means and the analysis unit such that the increasing or decreasing fill level between the monitoring means and the analysis unit is detected.

11. The monitoring arrangement according to claim 8, wherein the monitoring means has a direct contact with the liquid or is arranged outside of the liquid.

12. The monitoring arrangement according to claim 8, wherein the analysis unit is realized such that it detects a signal strength of the signal of the monitoring means.

13. The monitoring arrangement according to claim 8, wherein the monitoring means is arranged on a rod, which protrudes through an opening of the collecting chamber into the collecting space, wherein a connection line connects to the opening, via which connection line, the liquid collected in the collecting space can be drained.

14. The monitoring arrangement according to claim 13, wherein a valve is arranged in the course of the connection line, the valve being controlled via the analysis unit.

15. The monitoring arrangement according to claim 8, wherein the analysis unit is located outside of the collecting space.

16. The monitoring arrangement according to claim 8, wherein the monitoring arrangement is realized as a coherent component, which can be connected to the opening and further includes a housing, in which the analysis unit and a section of the connection line are arranged.

17. The monitoring arrangement according to claim 16, wherein the valve is arranged inside the housing.
